(19) United States
(12) Patent Application Publication
(10) Pub. No.: US 2020/0189942 A1
(43) Pub. Date: Jun. 18, 2020

(54) Alternating Current Electrodialysis

(71) Applicant: National Technology & Engineering Solutions of Sandia, LLC, Albuquerque, NM (US)

(72) Inventors: Leo J. Small, Albuquerque, NM (US); Erik David Spoerke, Albuquerque, NM (US)

(21) Appl. No.: 16/691,333

(22) Filed: Nov. 21, 2019

Related U.S. Application Data
(60) Provisional application No. 62/779,281, filed on Dec. 13, 2018.

(51) Int. Cl. C02F 1/469

(52) U.S. Cl. CPC C02F 1/4695; C02F 2201/4614; C02F 2201/46135; C02F 2201/46115

(57) ABSTRACT

An alternating current electrodialysis device that uses two synergistic energy efficiency-increasing improvements to a traditional electrodialysis system: (1) membranes which rectify ionic currents and (2) supercapacitor electrodes. Together these components enable alternating current electrodialysis, offering significantly decreased system complexity, improved energy efficiency, and increased systems lifetimes.

### CROSS-REFERENCE TO RELATED APPLICATION

This application claims the benefit of U.S. Provisional Application No. 62/779,281, filed Dec. 13, 2018, which is incorporated herein by reference.

### STATEMENT OF GOVERNMENT INTEREST

This invention was made with Government support under Contract No. DE-NA0003525 awarded by the United States Department of Energy/National Nuclear Security Administration. The Government has certain rights in the invention.

### FIELD OF THE INVENTION

The present invention relates to electrodialysis and, in particular, to alternating current electrodialysis.

### BACKGROUND OF THE INVENTION

Electrodialysis is an industrial-scale technique used to purify water. Here the application of a direct current (DC) electric field drives dissolved ions across ion-selective membranes to decrease the salt concentration and create a purified water stream. Due to the large electricity costs for operating such a facility, only a fraction of water purification plants are based on electrodialysis techniques, with the majority employing reverse osmosis (RO). Electrodialysis remains attractive, however, due to its ability to produce waters with lower ionic concentrations than achievable by RO.

### SUMMARY OF THE INVENTION

The present invention is directed to an alternating current electrodialysis system, comprising a first supercapacitor electrode and an opposing second supercapacitor electrode, spaced apart from each other by a flowing electrolyte stream comprising anions and cations; at least one ion-rectifying anion exchange membrane in the space between the supercapacitor electrodes which allows only anions to pass in a preferred direction toward the first supercapacitor electrode; and at least one ion-rectifying cation exchange membrane in the space between the supercapacitor electrodes which allows only cations to pass in an opposite preferred direction toward the opposing second supercapacitor electrode;

wherein an alternating current voltage is applied between the first supercapacitor electrode and the opposing second supercapacitor electrode such that anions pass through the ion-rectifying anion exchange membrane in the preferred direction and are driven towards the first supercapacitor electrode and cations pass through the ion-rectifying cation exchange membrane in the opposite preferred direction and are driven toward the opposing second supercapacitor electrode during a first half cycle of the alternating current voltage such that the concentration of anions and cations is modified in a portion of the electrolyte stream flowing between the ion-rectifying anion exchange membrane and the ion-rectifying cation exchange membrane, and wherein anions and cations are inhibited from passing through either of the ion-rectifying membranes during a second half cycle of the alternating current voltage. For example, the supercapacitor electrodes can comprise porous carbon, carbon nanoparticles, carbon nanotubes, graphene, or MoS₂. For example, the ion-rectifying ion exchange membranes can comprise cone-shaped nanopores with a charged inner surface, or cylindrical nanopores with an asymmetric inner surface charge.

### BRIEF DESCRIPTION OF THE DRAWINGS

The detailed description will refer to the following drawings, wherein like elements are referred to by like numbers.

FIG. 1 is a schematic illustration of a conventional direct current electrodialysis (DC ED) system with anion-selective and cation-selective membranes.

FIG. 2 is a schematic illustration depicting ion movement in an alternating current electrodialysis (AC ED) system, comprising ion rectifying membranes and porous supercapacitor electrodes, during the first half of the AC voltage period. During this time ions cross the membranes and water is purified in the center feed channel.

FIG. 3 is a schematic illustration depicting ion movement in the AC ED system during the second half of the AC voltage period. Ideally, no ions cross the rectifying membranes and no water is purified during this time period.

### DETAILED DESCRIPTION OF THE INVENTION

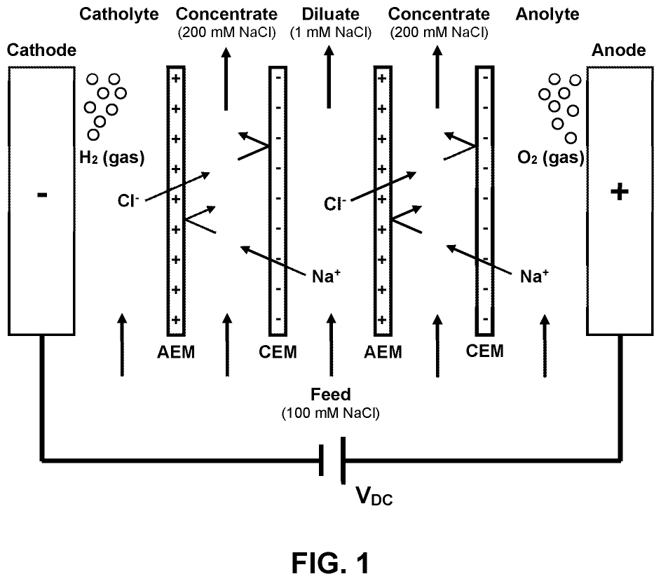

A schematic illustration of a typical direct-current electrodialysis (DC ED) cell system is shown in FIG. 1. This cell comprises a diluate compartment and two concentrate compartments formed by anion exchange membranes (AEM) and cation exchange membranes (CEM) placed in an aqueous electrolyte between two electrodes. Here a DC voltage is constantly applied between the solid, low capacity anode (+) and cathode (−) electrodes, resulting in movement of ions through the system. The use of anion-selective and cation-selective semi-permeable membranes limits ion movement and creates streams of water with increased or decreased ion concentrations relative to the starting feed concentration. In this example, ion-selective membranes are used to transport salt (e.g., NaCl) from one solution, the diluate, to another solution, the concentrate, by applying an electrical DC voltage to the electrodialysis cell. The feed stream (e.g., 100 mM NaCl) is allowed to flow through the appropriate cell compartments formed by the ion-selective membranes. The electrodes establish an electric field which drives the dissolved Na⁺ and Cl⁻ ions in opposite directions across the cell. Under the influence of the electrical potential difference, the negatively charged anions (Cl⁻) in the feed stream migrate toward the positively charged anode. These anions pass through the positively charged AEM but are prevented from further migration toward the anode by the negatively charged

CEM and therefore stay in the concentrate stream, which becomes concentrated with the anions. The positively charged cations (Na⁺) in the feed stream migrate toward the negatively charged cathode and pass through the negatively charged CEM. Cations in the concentrate stream are prevented from further migration toward the cathode by the positively charged AEM. As a result of the anion and cation migration, electric current flows between the cathode and anode. The overall result of the electrodialysis process is a depletion in the salt content in the center diluate compartment (e.g., 1 mM NaCl) and an enrichment in the salt content in the concentrate compartments (e.g., 200 mM NaCl). During operation, hydrogen and oxygen are evolved via electrolysis of water at the cathode and anode, respectively. The evolution of these gases is not productive towards the overall movement of ions; their formation represents a direct loss in the overall efficiency of the system.

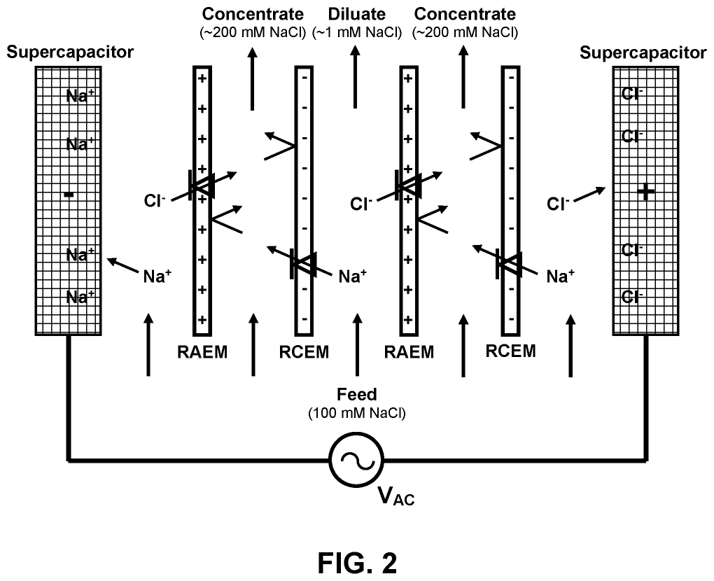

An alternating current electrodialysis (AC ED) cell of the present invention is illustrating in FIG. 2, which shows ion movement during the first half of the AC voltage period. The AC ED cell contains ion-rectifying anion exchange membranes (RAEM) and ion-rectifying cation exchange membranes (RCEM) and opposing supercapacitor electrodes arranged in a parallel-plate configuration. A coaxial configuration can also be used. Like the AEM and CEM of the DC ED cell, only Cl⁻ can pass through the RAEM, and only Na⁺ can pass through the RCEM. The rectifying nature of the RAEM and RCEM, however, imparts a diode-like quality to the membrane, only allowing current to travel in one direction through the membrane. Thus, the RAEM only allows Cl⁻ to pass, and the Cl⁻ is only allowed to move from left to right toward the positively charged supercapacitor electrode, as further described by the diode circuit element. In the RCEM, only Na⁺ is allowed to pass, and it is restricted to moving from right to left toward the negatively charged supercapacitor electrode. During the first half of the voltage cycle, the ion movement in the AC ED cell appears similar to that of the DC ED cell. The one exception is the large, porous, supercapacitor electrodes that provide enough capacitance (and current) to preclude O₂ and H₂ evolution at the electrodes. Instead, Na⁺ and Cl⁻ are simply adsorbed, increasing energy efficiency.

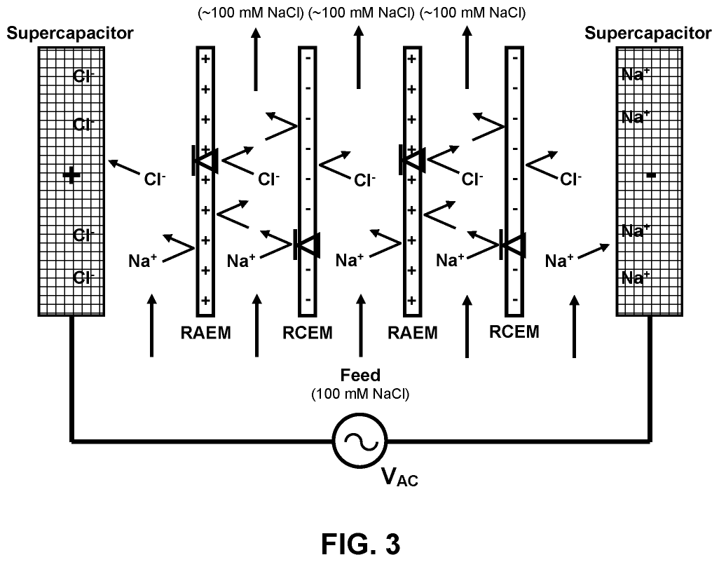

Ion movement in the AC ED cell during the second half of the voltage cycle is illustrated in FIG. 3. During this part of the voltage cycle, ideally no ions cross the membranes. Ions are repelled from crossing a membrane by either being the wrong type (anion vs. cation) or attempting to move across the membrane in the wrong direction, opposing the rectifying nature of the membranes. During this part of the cycle, however, the supercapacitor electrodes desorb their previously adsorbed species for one of the opposite charge (e.g. at the now positively charged supercapacitor electrode, Na⁺ is exchanged for Cl⁻).

The AC ED cell of the present invention offers several benefits compared to the conventional DC ED system. By using membranes that rectify ion transport, the rectifying membranes serve as ionic diodes that limit backward motion of ions. In the AC ED system, this rectification effectively reduces the field required to prevent “backflow” of separated ions, lowering system costs, and allows the system to be turned off without suffering recontamination of purified water from these backflowing ions. More significantly, however, this rectification also enables the highly desirable, less expensive AC voltage system. The use of AC voltage is advantageous, as it eliminates the need for DC power converters, allowing appropriately designed systems to be plugged straight into a standard 110 V wall outlet. Furthermore, use of AC power helps decrease fouling of the system. The constant reversal of voltage polarity is reminiscent of the technique electrodialysis reversal (EDR), whereby the polarity of the DC voltage is periodically reversed to decrease ionic fouling and extend the system lifetime. AC systems are not used today because applying AC voltage to a traditional electrodialysis system would result in no net ion movement. As the polarity of the AC fields is constantly reversed, separated ions would be moved back and forth across a traditional membrane, resulting in no net separation of ions. By inserting a rectifying, ion-selective membrane, once the ions are moved across the membrane, even when the field is reversed, they remain “trapped” by the rectifying membrane, isolated from the freshly purified water. Of course, the AC ED system can be used to purify other ionic solutions, including non-aqueous electrolyte systems and other ionic salt compounds, besides the exemplary NaCl aqueous solution. Ion rectification allows ions to flow in a preferential direction. Rectifying ion exchange membranes comprise nanochannels exhibiting ion transport properties similar to biological ion channels. There are a variety of ways to make rectifying ion exchange membranes. For example, the membrane can comprise cone-shaped nanopores with a charged inner surface that selectively allows ions to flow whose charge is opposite the surface charge. See L. J. Small et al., U.S. Pat. No. 9,387,444, issued Jul. 12, 2016, which is incorporated herein by reference. Further, the asymmetric structure of the conical pores enables rectification of the ion flow in a preferred direction, whilst inhibiting flow in the opposite direction. The preferred flow direction is from the smaller opening of the conical pore to the larger opening. Such conical nanopores have been shown to efficiently pump ions to desalinate water using oscillating electric fields. See Y. Zhang and G. C. Schatz, J. Phys. Chem. Lett. 8, 2842 (2017), which is incorporated herein by reference. Another way to make an ionically rectifying membrane is to vary the surface charge density asymmetrically through cylindrical pores. See Q. Zhang et al., Adv. Funct. Mater. 24, 424 (2014), which is incorporated herein by reference.

The present invention uses supercapacitor electrodes to accept charge during the first half cycle and rapidly reverse charge during the second half cycle. Supercapacitor electrodes comprise a high surface area material with enough surface area and capacitance to supply the needed current during one AC cycle and prevent O₂ and H₂ evolution. In these electrochemical supercapacitors, charges can be stored and separated reversibly at the interface between the active surface of the electrode and the electrolyte. Typical high surface area materials include porous carbon, carbon nanoparticles, carbon nanotubes, graphene, and MoS₂. See P. Simon and Y. Gogotsi, Acc. Chem. Res. 46(5), 1094 (2013); G. Wang et al., Chem. Soc. Rev. 41, 797 (2012); and Z. Yu et al., Energy Environ. Sci. 8, 702 (2015), which are incorporated herein by reference. Synergistically, high surface area supercapacitor electrodes leverage the use of an AC current by enabling recovery of electrical work in a given period of the AC signal, resulting in a lower impedance, higher efficiency system. In a standard DC electrodialysis system, hydrogen and oxygen are continuously evolved at the flat, planar cathode and anode, respectively. The evolution of these gases represents an irreversible energy loss. By employing supercapacitor electrodes, evolution of these gases can be altogether avoided, as the high surface area electrodes themselves provide sufficient charge for the system, obviating the need for water electrolysis to balance the accumulation of charge from ions separated during ED. In such a system, during the first half cycle of the AC signal period the supercapacitor electrodes are charged with ions driven in the preferred direction, followed by charge reversal during the second half cycle. The second half cycle is not productive towards moving the ions in the preferred direction (for separation), however, as described above, the use of ionically rectifying membranes prevents backflow of ions and maintains the established concentration gradient.

Together, ion rectifying membranes and supercapacitor electrodes enable high-efficiency electrodialysis systems powered directly by widely-available AC power. These enabling advantages are expected to reduce critical costs associated with ED, making it more commercially viable and cost competitive with currently used, less effective RO systems.

The present invention has been described as an alternating current electrodialysis system. It will be understood that the above description is merely illustrative of the applications of the principles of the present invention, the scope of which is to be determined by the claims viewed in light of the specification.

Other variants and modifications of the invention will be apparent to those of skill in the art.

We claim:

1. An alternating current electrodialysis system, comprising:
a first supercapacitor electrode and an opposing second supercapacitor electrode, spaced apart from each other by a flowing electrolyte stream comprising anions and cations;
at least one ion-rectifying anion exchange membrane in the space between the supercapacitor electrodes which allows only anions to pass in a preferred direction toward the first supercapacitor electrode; and
at least one ion-rectifying cation exchange membrane in the space between the supercapacitor electrodes which allows only cations to pass in an opposite preferred direction toward the opposing second supercapacitor electrode;
wherein an alternating current voltage is applied between the first supercapacitor electrode and opposing second supercapacitor electrode such that anions pass through the ion-rectifying anion exchange membrane in the preferred direction and are driven towards the first supercapacitor electrode and cations pass through the ion-rectifying cation exchange membrane in the opposite preferred direction and are driven toward the opposing second supercapacitor electrode during a first half cycle of the alternating current voltage such that the concentration of anions and cations is modified in a portion of the electrolyte stream flowing between the ion-rectifying anion exchange membrane and the ion-rectifying cation exchange membrane, and
wherein anions and cations are inhibited from passing through either the ion-rectifying membrane during a second half cycle of the alternating current voltage.

2. The alternating current electrodialysis system of claim 1, wherein the first supercapacitor electrode or the opposing second supercapacitor electrode comprises porous carbon, carbon nanoparticles, carbon nanotubes, graphene, or MoS₂.

3. The alternating current electrodialysis system of claim 1, wherein the ion-rectifying anion exchange membrane or ion-rectifying cation exchange membrane comprises cone-shaped nanopores with a charged inner surface.

4. The alternating current electrodialysis system of claim 1, wherein the ion-rectifying anion exchange membrane or ion-rectifying cation exchange membrane comprises symmetric nanopores with an asymmetric inner surface charge.

5. The alternating current electrodialysis system of claim 1, wherein the first supercapacitor electrode, the opposing second supercapacitor electrode, the at least one ion-rectifying anion exchange membrane, and the at least one ion-rectifying cation exchange membrane are arranged in a parallel-plate configuration.

6. The alternating current electrodialysis system of claim 1, wherein the first supercapacitor electrode, the opposing second supercapacitor electrode, the at least one ion-rectifying anion exchange membrane, and the at least one ion-rectifying cation exchange membrane are arranged in a coaxial configuration.

7. The alternating current electrodialysis system of claim 1, wherein the at least one ion-rectifying anion exchange membrane and the at least one ion-rectifying cation exchange membrane comprise two ion-rectifying anion exchange membranes and two ion-rectifying cation exchange membranes that are spaced apart from each other in an alternating sequence.
